(19) United States
(12) Patent Application Publication
(10) Pub. No.: US 2025/0358733 A1
(43) Pub. Date: Nov. 20, 2025

(54) MACHINE LEARNING ASSISTED ENERGY SAVING OPTIMIZATION IN A WIRELESS COMMUNICATIONS SYSTEM (WCS)

(71) Applicant: ANI Acquisition Sub, LLC, Boca Raton, FL (US)

(72) Inventors: Manjit Singh Duhan, Haryana (IN); Atul Singh, Uttar Pradesh (IN); Sukhvinder Singh Malik, Haryana (IN)

(73) Assignee: ANI Acquisition Sub, LLC, Boca Raton, FL (US)

(21) Appl. No.: 19/211,155

(22) Filed: May 17, 2025

Related U.S. Application Data
(60) Provisional application No. 63/648,856, filed on May 17, 2024.

(51) Int. Cl. H04W 52/02; G06F 18/2415

(52) U.S. Cl. CPC H04W 52/0206; G06F 18/2415

(57) ABSTRACT

Machine learning (ML) assisted energy saving optimization in a wireless communications system (WCS) is provided. The WCS includes multiple radio nodes (RNs) each configured to provide radio frequency (RF) coverage in a coverage area. In a conventional approach, each RN emits high RF power to maintain sufficient signal strength at a respective edge of the coverage area, regardless of whether users (stationary and mobile) are present and how users are distributed in the coverage area. To help reduce potential energy waste, the WCS is configured to utilize a sensor network and invoke an ML service to help detect user presence, determine user distribution, and optimize transmit power in the coverage area. As a result, it is possible to configure each RN to radiate an appropriate amount of RF energy based on actual user distribution in the coverage area, thus helping to reduce unnecessary energy waste in the WCS.

### CROSS-REFERENCE TO RELATED APPLICATIONS

This application claims the benefit of priority under 35 U.S.C. § 119(e) of U.S. Provisional Application No. 63/648,856, filed May 17, 2024, the contents of which are incorporated herein by reference in its entirety.

### BACKGROUND

The disclosure relates generally to using machine learning to optimize energy saving in a wireless communications system (WCS), which can include a fifth generation (5G) system, a 5G new-radio (5G-NR) system, and/or a distributed communications system (DCS).

Wireless communication is rapidly growing, with ever-increasing demands for high-speed mobile data communication. As an example, local area wireless services (e.g., so-called “Wi-Fi” systems) and wide area wireless services are being deployed in many different types of areas (e.g., coffee shops, airports, libraries, etc.). Communications systems have been provided to transmit and/or distribute communications signals to wireless nodes called “clients,” “client devices,” or “wireless client devices,” which must reside within the wireless range or “cell coverage area” in order to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of radio nodes/base stations that transmit communications signals distributed over physical communications medium remote units forming RF antenna coverage areas, also referred to as “antenna coverage areas.” The remote units each contain or are configured to couple to one or more antennas configured to support the desired frequency(ies) of the radio nodes to provide the antenna coverage areas. Antenna coverage areas can have a radius in a range from a few meters up to twenty meters, as an example. Another example of a communications system includes radio nodes, such as base stations, that form cell radio access networks, wherein the radio nodes are configured to transmit communications signals wirelessly directly to client devices without being distributed through intermediate remote units.

For example, FIG. 1 is an example of a WCS 100 that includes a radio node 102 configured to support one or more service providers 104(1)-104(N) as signal sources (also known as “carriers” or “service operators”—e.g., mobile network operators (MNOs)) and wireless client devices 106(1)-106(W). For example, the radio node 102 may be a base station (eNodeB) that includes modem functionality and is configured to distribute communications signal streams 108(1)-108(S) to the wireless client devices 106(1)-106(W) based on communications signals 110(1)-110(N) received from the service providers 104(1)-104(N). The communications signal streams 108(1)-108(S) of each respective service provider 104(1)-104(N) in their different spectrums are radiated through an antenna 112 to the wireless client devices 106(1)-106(W) in a communication range of the antenna 112. For example, the antenna 112 may be an antenna array. As another example, the radio node 102 in the WCS 100 in FIG. 1 can be a small cell radio access node (“small cell”) that is configured to support the multiple service providers 104(1)-104(N) by distributing the communications signal streams 108(1)-108(S) for the multiple service providers 104(1)-104(N) based on respective communications signals 110(1)-110(N) received from a respective evolved packet core (EPC) network CN₁-CN_{N} of the service providers 104(1)-104(N) through interface connections. The radio node 102 includes radio circuits 118(1)-118(N) for each service provider 104(1)-104(N) that are configured to create multiple simultaneous RF beams (“beams”) 120(1)-120(N) for the communications signal streams 108(1)-108(S) to serve multiple wireless client devices 106(1)-106(W). For example, the multiple RF beams 120(1)-120(N) may support multiple-input, multiple-output (MIMO) communications.

The radio node 102 of the WCS 100 in FIG. 1 may be configured to support service providers 104(1)-104(N) that have a different frequency spectrum and do not share the spectrum. Thus, in this instance, the communications signals 110(1)-110(N) from the different service providers 104(1)-104(N) do not interfere with each other even if transmitted by the radio node 102 at the same time. The radio node 102 may also be configured as a shared spectrum communications system where the multiple service providers 104(1)-104(N) have a shared spectrum. In this regard, the capacity supported by the radio node 102 for the shared spectrum is split (i.e., shared) between the multiple service providers 104(1)-104(N) for providing services to the subscribers.

The radio node 102 in FIG. 1 can also be coupled to a distributed communications system (DCS), such as a distributed antenna system (DAS), such that the radio circuits 118(1)-118(N) remotely distribute the communications signals 110(1)-110(N) of the multiple service providers 104(1)-104(N) to remote units. The remote units can each include an antenna array that includes tens or even hundreds of antennas for concurrently radiating the communications signals 110(1)-110(N) to subscribers using spatial multiplexing. Herein, the spatial multiplexing is a scheme that takes advantage of the differences in RF channels between transmitting and receiving antennas to provide multiple independent streams between the transmitting and receiving antennas, thus increasing throughput by sending data over parallel streams. Accordingly, the remote units can be said to radiate the communications signals 110(1)-110(N) to subscribers based on a massive multiple-input multiple-output (M-MIMO) scheme.

### SUMMARY

Embodiments disclosed herein include machine learning (ML) assisted energy saving optimization in a wireless communications system (WCS). The WCS includes multiple radio nodes (RNs) each configured to provide radio frequency (RF) coverage in a coverage area. In a conventional approach, each RN emits high RF power to maintain sufficient signal strength at a respective edge of the coverage area, regardless of whether users (stationary and mobile) are present and how users are distributed in the coverage area. To help reduce potential energy waste, the WCS is configured to utilize a sensor network and invoke an ML service to help detect user presence, determine user distribution, and optimize transmit power in the coverage area. As a result, it is possible to configure each RN to radiate an appropriate amount of RF energy based on actual user distribution in the coverage area, thus helping to reduce unnecessary energy waste in the WCS.

One exemplary embodiment of the disclosure relates to a method for optimizing energy saving in a WCS. The method includes receiving a set of sensory data collected for one or more RNs among a plurality of RNs in the WCS. The method also includes invoking an ML service to process the set of sensory data to thereby assign each of the one or more RNs to a power category. The method also includes optimizing the assigned power category to thereby determine an optimized transmit power for each of the one or more RNs. The method also includes configuring each of the one or more RNs to transmit in the optimized transmit power.

An additional exemplary embodiment of the disclosure relates to a WCS. The WCS includes a plurality of RNs. Each of the plurality of RNs is configured to serve a respective one of a plurality of coverage areas. The WCS also includes a proximity sensor network. The proximity sensor network co-exists with the plurality of RNs. The proximity sensor network is configured to collect a set of sensory data for one or more RNs among a plurality of RNs in the WCS. The WCS also includes a computing device. The computing device is configured to receive the set of sensory data from the sensor network. The computing device is also configured to invoke an ML service to process the set of sensory data to thereby assign each of the one or more RNs to a power category. The computing device is also configured to optimize the assigned power category to thereby determine an optimized transmit power for each of the one or more RNs. The computing device is also configured to configure each of the one or more RNs to transmit in the optimized transmit power.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary wireless communications system (WCS), such as a distributed communications system (DCS), configured to distribute communications services to remote coverage areas;

FIG. 2 is a schematic diagram of an exemplary existing WCS, such as the WCS of FIG. 1, wherein multiple radio nodes (RNs) are configured to emit high radio frequency (RF) energy to provide a blanket RF coverage in an indoor environment;

FIG. 3 is a schematic diagram of an exemplary WCS wherein machine learning (ML) assisted energy saving optimization can be enabled according to embodiments of the present disclosure;

FIG. 4 is a flowchart of an exemplary high-level process whereby the WCS of FIG. 3 can be configured to enable ML assisted energy saving optimization;

FIG. 5 is a flowchart of an exemplary low-level process that is invoked by the high-level process of FIG. 4;

FIG. 6 is a schematic diagram of an exemplary computing device configured to carry out the high-level process of FIG. 4 and the low-level process of FIG. 6;

FIG. 7 is a partial schematic cut-away diagram of an exemplary building infrastructure in a WCS, such as the WCS of FIG. 3 that includes the computing device of FIG. 6 to perform ML assisted energy saving optimization.

FIG. 8 is a schematic diagram of an exemplary mobile telecommunications environment that can includes the WCS of FIG. 3 that includes the computing device of FIG. 6 to perform ML assisted energy saving optimization; and

FIG. 9 is a schematic diagram of a representation of an exemplary computer system that can be included in or interfaced with any of the components in the WCS of FIG. 3 and the computing device in FIG. 6 to perform ML assisted energy saving optimization, wherein the exemplary computer system is configured to execute instructions from an exemplary computer-readable medium.

### DETAILED DESCRIPTION

Embodiments disclosed herein include machine learning (ML) assisted energy saving optimization in a wireless communications system (WCS). The WCS includes multiple radio nodes (RNs) each configured to provide radio frequency (RF) coverage in a coverage area. In a conventional approach, each RN emits high RF power to maintain sufficient signal strength at a respective edge of the coverage area, regardless of whether users (stationary and mobile) are present and how users are distributed in the coverage area. To help reduce potential energy waste, the WCS is configured to utilize a sensor network and invoke an ML service to help detect user presence, determine user distribution, and optimize transmit power in the coverage area. As a result, it is possible to configure each RN to radiate an appropriate amount of RF energy based on actual user distribution in the coverage area, thus helping to reduce unnecessary energy waste in the WCS.

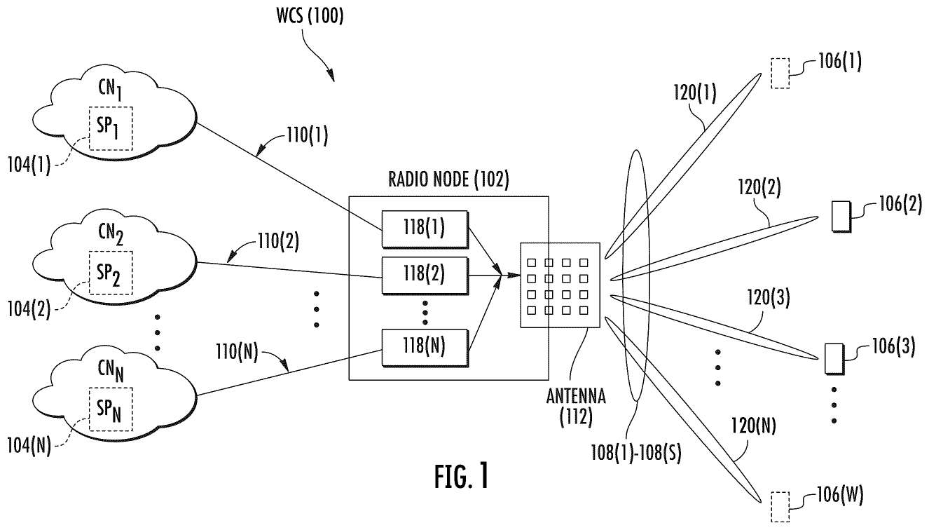

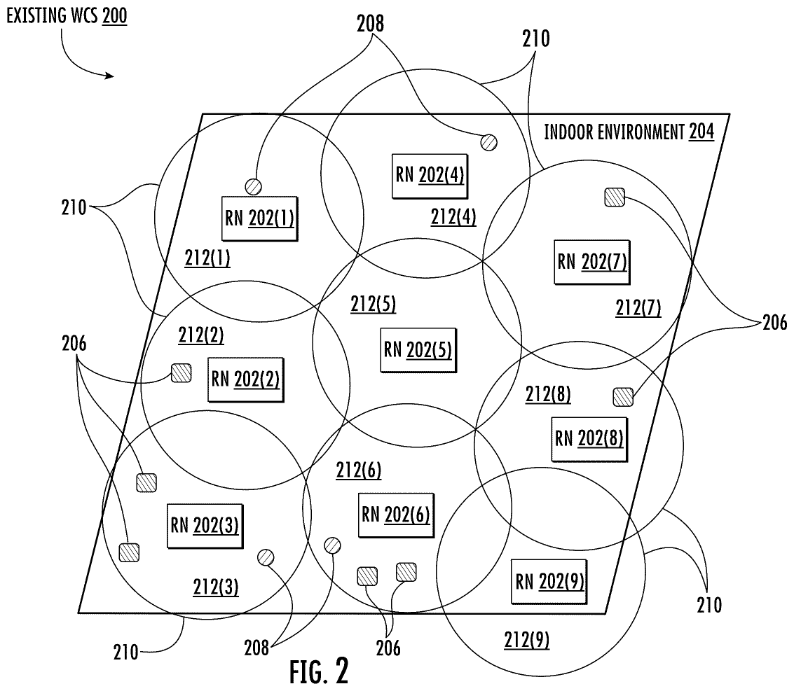

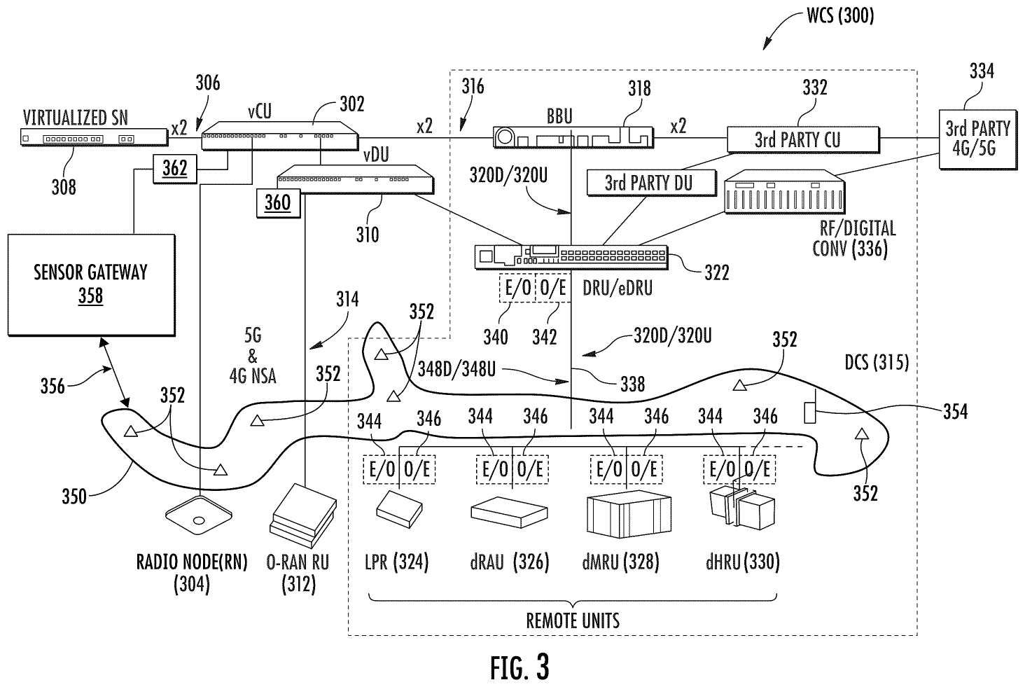

Before discussing aspects of the present disclosure, starting at FIG. 3, a brief overview of an existing WCS, such as the WCS 100 of FIG. 1, is first provided with reference to FIG. 2 to help explain the technical problems to be solved herein.

FIG. 2 is a schematic diagram of an exemplary existing WCS 200 wherein multiple RNs 202(1)-202(9) are configured to emit high RF energy to provide a blanket RF coverage in an indoor environment 204. Herein, the WCS 200 may be equivalent to the WCS 100 of FIG. 1 and, accordingly, the RNs 202(1)-202(9) may be equivalent to the radio node 102 in the WCS 100. Notably, the RNs 202(1)-202(9) are provided herein merely for the purpose of illustration. The WCS 200 can include more RNs depending on the size of the indoor environment 204 and the coverage requirements of the WCS 200.

Specifically, each of the RNs 202(1)-202 may be configured to serve a respective one or more stationary devices 206 (e.g., wireless printer, copier machine, security camera, etc.) and/or a respective one or more mobile devices 208 (e.g., smartphone, laptop computer, handheld scanner, etc.) that are located within a respective edge 210 of a respective one of multiple coverage areas 212(1)-212(9). As an example, each of the RNs 202(1)-202(4) and 202(6)-202(8) may each serve the stationary devices 206 and/or the mobile devices 208 in its respective coverage areas 212(1)-212(4) and 212(6)-212(8), whereas the RNs 202(5), 202(9) do not have any of the stationary devices 206 and the mobile devices 208 located in their respective coverage areas 212(5), 212(9). Moreover, in the coverage areas 212(1)-212(4) and 212(6)-212(8), the stationary devices 206 and/or the mobile devices 208 may be located closer to their respective RNs 202(1)-202(4) and 202(6)-202(8) than to the respective edge 210.

Nevertheless, in a conventional configuration, each of the RNs 202(1)-202(9) is configured to emit high RF energy to maintain a sufficient signal strength at the edge 210, regardless of whether the stationary devices 206 and the mobile devices 208 are present in the respective coverage areas 212(1)-212(9) and, if so, how the stationary devices 206 and the mobile devices 208 are distributed in the respective coverage areas 212(1)-212(9). As a result, the RNs 202(1)-202(9) may emit more RF energy than needed and waste tremendous amount of energy. In this regard, it is desirable to configure each of the RNs 202(1)-202(9) to emit RF energy based on presence and/or distribution of the stationary device(s) 208 and the mobile device(s) 210 in their respective coverage areas 212(1)-212(9).

FIG. 3 is a schematic diagram of an exemplary WCS 300 wherein machine learning (ML) assisted energy saving optimization can be enabled according to embodiments of the present disclosure. The WCS 300 supports both legacy 4G LTE, 4G/5G non-standalone (NSA), and 5G standalone communications systems. As shown in FIG. 3, a centralized services node 302 is provided and is configured to interface with a core network to exchange communications data and distribute the communications data as radio signals to various wireless nodes. In this example, the centralized services node 302 is configured to support distributed communications services to a radio node 304 (e.g., 5G or 5G-NR gNB). Despite the fact that only one radio node 304 is shown in FIG. 3, it should be appreciated that the WCS 300 can be configured to include additional numbers of the radio node 304, as needed.

The functions of the centralized services node 302 can be virtualized through, for example, an x2 interface 306 to another services node 308. The centralized services node 302 can also include one or more internal radio nodes that are configured to be interfaced with a distribution unit (DU) 310 to distribute communications signals to one or more open radio access network (O-RAN) remote units (RUs) 312 that are configured to be communicatively coupled through an O-RAN interface 314. The O-RAN RUs 312 are each configured to communicate downlink and uplink communications signals in a respective coverage cell.

The centralized services node 302 can also be interfaced with a distributed communications system (DCS) 315 through an x2 interface 316. Specifically, the centralized services node 302 can be interfaced with a digital baseband unit (BBU) 318 that can provide a digital signal source to the centralized services node 302. The digital BBU 318 may be configured to provide a signal source to the centralized services node 302 to provide downlink communications signals 320D to a digital routing unit (DRU) 322 as part of a digital distributed antenna system (DAS). The DRU 322 is configured to split and distribute the downlink communications signals 320D to different types of remote units, including a low-power remote unit (LPR) 324, a radio antenna unit (dRAU) 326, a mid-power remote unit (dMRU) 328, and a high-power remote unit (dHRU) 330. The DRU 322 is also configured to combine uplink communications signals 320U received from the LPR 324, the dRAU 326, the dMRU 328, and the dHRU 330 and provide the combined uplink communications signals to the digital BBU 318. The digital BBU 318 is also configured to interface with a third-party central unit 332 and/or an analog source 334 through a radio frequency (RF)/digital converter 336.

The DRU 322 may be coupled to the LPR 324, the dRAU 326, the dMRU 328, and the dHRU 330 via an optical fiber-based communications medium 338. In this regard, the DRU 322 can include a respective electrical-to-optical (E/O) converter 340 and a respective optical-to-electrical (O/E) converter 342. Likewise, each of the LPR 324, the dRAU 326, the dMRU 328, and the dHRU 330 can include a respective E/O converter 344 and a respective O/E converter 346.

The E/O converter 340 at the DRU 322 is configured to convert the downlink communications signals 320D into downlink optical communications signals 348D for distribution to the LPR 324, the dRAU 326, the dMRU 328, and the dHRU 330 via the optical fiber-based communications medium 338. The O/E converter 346 at each of the LPR 324, the dRAU 326, the dMRU 328, and the dHRU 330 is configured to convert the downlink optical communications signals 348D back to the downlink communications signals 320D. The E/O converter 344 at each of the LPR 324, the dRAU 326, the dMRU 328, and the dHRU 330 is configured to convert the uplink communications signals 320U into uplink optical communications signals 348U. The O/E converter 342 at the DRU 322 is configured to convert the uplink optical communications signals 348U back to the uplink communications signals 320U.

In context of the present disclosure, a radio node (RN) refers generally to a wireless communication circuit including at least a processing circuit, a memory circuit, and an antenna circuit, and can be configured to process and transmit a wireless communications signal. In this regard, the radio node 304, the O-RAN RU 312, the LPR 324, the dRAU 326, the dMRU 328, and the dHRU 330 can all function as the RN. Accordingly, the WCS 300 can be said to include multiple RNs 304, 312, 324, 326, 328, and 330. Understandably, the WCS 300 can include any number of the radio node 304, the O-RAN RU 312, the LPR 324, the dRAU 326, the dMRU 328, and the dHRU 330.

Herein, the WCS 300 co-exists with a sensor network 350 including multiple sensors 352. In a non-limiting example, the sensors 352 can be proximity sensors (e.g., motion sensors, light sensors, noise sensors, radiation sensors, heat sensors, etc.) that can generate a triggered response when being approached by a mobile device 354 in the WCS 300. More specifically, the sensors 352 can be configured to provide a set of sensory data 356, which includes such information as proximity status and sensor identification, to a sensory gateway (SG) 358.

A computing device 360, which can be a personal computer or a cloud-based computing server, as an example, is interfaced with the sensor gateway 358 via a cross-platform application (xApp) 362 and configured to retrieve the set of sensory data 356 from the sensor gateway 358. In an embodiment, the computing device 360 may be collocated with the distribution unit (DU) 310 or the centralized services node 302. The cross-platform application 362, which can be provided in the computing device 360 or the sensor gateway 358, is configured to enable communications between the sensor gateway 358 and the computing device 360.

The computing device 360 is further configured to invoke an ML service to process the received set of sensory data 356. The ML service, which may be part of the xApp 362, can analyze the set of sensory data 356 and, accordingly, provide an energy saving recommendation(s) to the computing device 360. The computing device 360, in turn, may execute additional optimization algorithms to further optimize the energy saving recommendation(s) provided by the ML service to thereby provide ML assisted energy saving optimization in the WCS 300.

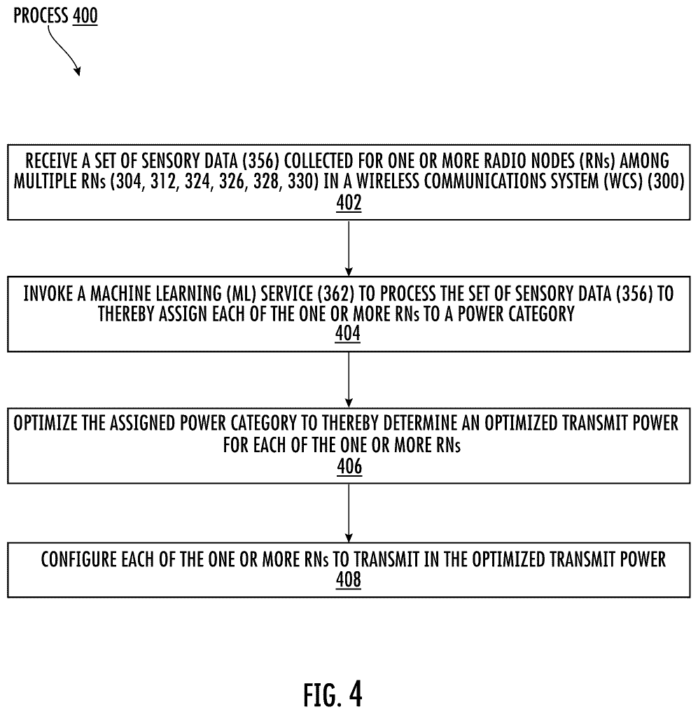

FIG. 4 is a flowchart of an exemplary high-level process 400 whereby the computing device 360 in the WCS 300 of FIG. 3 can be configured to enable ML assisted energy saving optimization in the WCS 300. Common elements between FIGS. 3 and 4 are referenced therein with common element numbers and will not be re-described herein.

Herein, the computing device 360 is configured to receive the set of sensory data 356, which may be collected by the sensors 352 for the RNs 304, 312, 324, 326, 328, and 330 in the WCS 300 (block 402). In an embodiment, the computing device 360 may receive the set of sensory data 356 via such Internet-of-Things (IoT) protocols as Message Queuing Telemetry Transport (MQTT), Constrained Application Protocol (CoAP), and Lightweight Machine-to-Machine (LWM2M).

In one embodiment, with the MQTT protocol, the xApp 362 subscribes to a predefined topic of each of the sensors 352. Each of the sensors 352 publishes its status (on or off) on the respective predefined topic. The xApp 362 can thus detect proximity status in the WCS 300 based on location of the sensors 352.

In another embodiment, with the CoAP protocol, the xApp 362 adds an observer on a corresponding uniform resource identifier (URI) of each sensor 352. Whenever the status of the sensor 352 changes, a CoAP server will mark a data on the corresponding URI as being changed. The xApp 362, in turn, gets a PUT/POST event from the CoAP server and, accordingly, can detect the proximity status in the WCS 300 based on a location of the sensors 352.

In response to receiving the set of sensory data 356, the computing device 360 invokes an ML service to process the set of sensory data 356 to thereby assign each of the RNs 304, 312, 324, 326, 328, and 330 to a respective power category (block 404). In an embodiment, the ML service can execute a classification algorithm to determine a respective user cluster for each of the RNs 304, 312, 324, 326, 328, and 330 based on the set of sensory data 356. Notably, the user cluster for each of the RNs 304, 312, 324, 326, 328, and 330 is determined based on actual distribution in a respective coverage area. Using the indoor environment 204 in FIG. 2 as an example, the user cluster defined by the ML service would be smaller than the coverage areas 212(1)-212(4) and 212(6)-212(8) because both the stationary devices 206 and the mobile devices 208 in these coverage areas are closer to the RNs 202(1)-202(4) and 202(6)-202(8) than to the edge 210.

The ML service then classifies the respective user cluster defined for each of the RNs 304, 312, 324, 326, 328, and 330 into a respective power category. In an embodiment, the power category can include a power-off category associated with a first power level that equals zero, a low-power category associated with a second power level higher than the first power level, a medium-power category associated with a third power level higher than the second power level, and a high-power category associated with a fourth power level higher than the third power level. Once again using the indoor environment 204 in FIG. 2 as an example, the ML service would assign the power-off category to the RNs 202(5), 202(9) since none of the stationary devices 206 and the mobile devices 208 is in the respective coverage areas 212(5), 212(9). As for the RNs 202(1)-202(4) and 202(6)-202(8), the ML service may assign them to any of the low-power category, the medium-power category, and the high-power category, depending on actual distribution of the stationary devices 206 and the mobile devices 208 in their respective coverage areas 212(1)-212(4) and 212(6)-212(8).

Subsequently, the ML service can provide an energy saving recommendation to the computing device 360. In an embodiment, the energy saving recommendation may include a respective identification (ID) of the RNs 304, 312, 324, 326, 328, and 330 in association with a respective power category that corresponds to a suggested transmit power (referred to as “P_{TX-SUG}” hereinafter).

Notably, the sensors 352 are more likely to be triggered by the mobile devices 354 than by any stationary device in the WCS 300. As such, the power category recommended by the ML service may inadvertently cause undesired consequences to the stationary devices. As such, the computing device 360 is further configured to determine an optimized transmit power (referred to as “P_{TX}” hereinafter) for each of the RNs 304, 312, 324, 326, 328, and 330 (block 406). More specifically, the computing device 360 needs to first validate the recommended power categories for the stationary devices to thereby determine the optimized transmit power P_{TX} and then configure the RNs 304, 312, 324, 326, 328, and 330 to transmit based on the optimized transmit power P_{T}X (block 408).

In an embodiment, the computing device 360 is configured to validate the recommended power categories and determine the optimized transmit power P_{TX} based on a stationary device table, which may be dynamically generated by any of the ML service, the xApp 362, and the computing device 360. Alternatively, the stationary device table may also be pre-generated elsewhere (e.g., during site planning) and preloaded onto the computing device 360. In a non-limiting example, the stationary device table can include a list of RNs each configured to serve at least one stationary device in the respective coverage area. Again, using the indoor environment 204 as an example, the RNs 202(2), 202(3), 202(6), 202(7), and 202(8) would land in the stationary device table because each of the RNs 202(2), 202(3), 202(6), 202(7), and 202(8) is configured to support the stationary device 206. In an embodiment, the stationary device table can be configured to include a respective RN ID and a respective transmit power level (referred to as “P_{TX-STA}” hereinafter) for each of the RNs in the stationary device table.

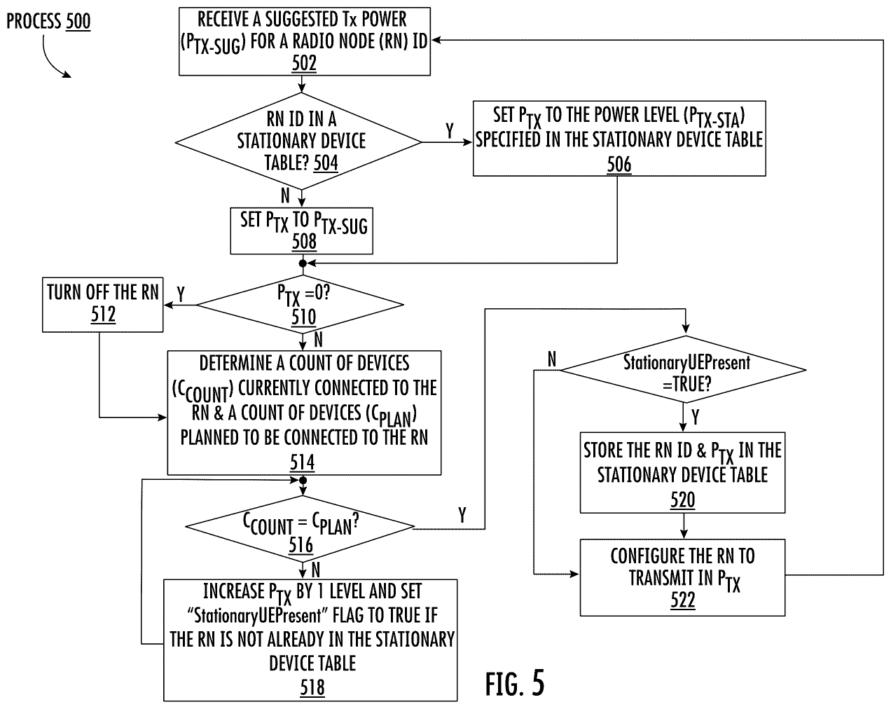

In an embodiment, the computing device 360 may be configured to execute a stationary device algorithm to validate the power categories for the stationary devices. FIG. 5 is a flowchart of an exemplary low-level process 500 that is invoked by the computing device 360 during the high-level process 400 of FIG. 4 for validating the power categories for the stationary devices.

Herein, the computing device 360 receives the energy saving recommendation from the ML service that includes the respective RN ID and the suggested transmit power P_{TX-SUG} (block 502). The computing device 360 checks whether the RN ID is in the stationary device table (block 504). If the RN ID is in the stationary device table, the computing device 360 then sets the optimized transmit power P_{TX} to the transmit power level P_{TX-STA} specified in the stationary device table (block 506). In contrast, if the RN ID is not in the stationary device table, the computing device 360 sets the optimized transmit power P_{TX} to the suggested transmit power P_{TX-SUG} (block 508). The computing device 360 then checks whether the optimized transmit power P_{TX} is equal to zero (block 510). If so, the computing device 360 will then power off the respective RN ID (block 512).

Next, the computing device 360 then obtains a count (referred to as “C_{COUNT}” hereinafter) of devices that are currently connected to the RN ID and a count (referred to as “C_{PLAN}” hereinafter) of devices that are planned to be connected to the RN ID (block 514). In an embodiment, the computing device 360 may obtain the count C_{COUNT} via radio resource control (RRC) layer signaling. The computing device 360 checks whether the C_{COUNT} is equal to the C_{PLAN} (block 516). If the C_{COUNT} does not equal the C_{PLAN}, the computing device 360 then increases the P_{TX} by one level (e.g., from the second power level associated with the low-power category to the third power level associated with the medium-power category) and sets a “StationaryUEPresent” flag to TRUE if the RN ID does not already exist in the stationary device table (block 518).

If the “StationaryUEPresent’ is TRUE, the computing device 360 will store the RN ID and the P_{TX} in the stationary device table (block 520). The computing device 360 then configures the RN to transmit in P_{TX} (block 522). The computing device 360 then returns to block 502 to process the next RN ID in the energy saving recommendation.

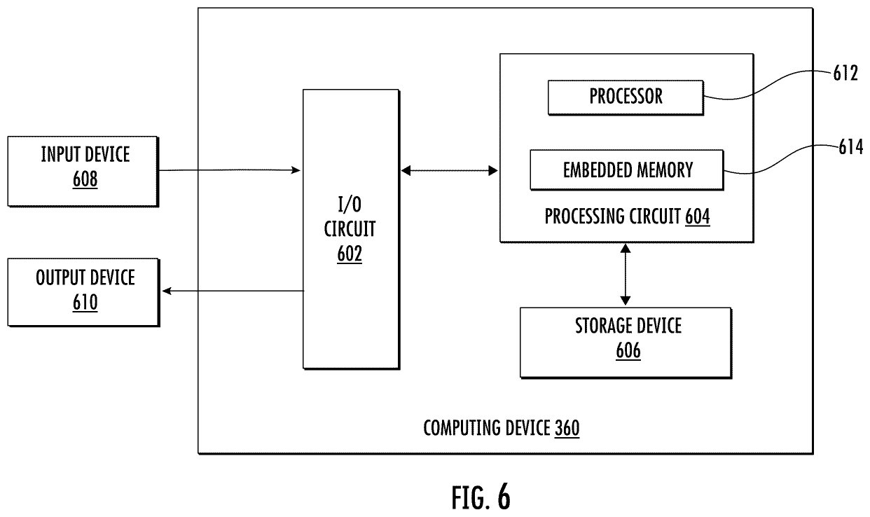

FIG. 6 is a schematic diagram providing an exemplary illustration of the computing device 360 in FIG. 3. Common elements between FIGS. 3 and 6 are shown therein with common element numbers and will not be re-described herein.

In an embodiment, the computing device 360 includes an input/output (I/O) circuit 602, a processing circuit 604, and a storage device 606. The I/O circuit 602 may include or be communicatively coupled to an input device 608 and an output device 610. The input device 608 may be a computer keyboard, a scanner, a media reader, and so on. The output device 610 may be a computer monitor, a printer, a portable or cloud-based storage device, and so on. According to an embodiment of the present disclosure, the input device 608 is coupled to the sensor gateway 358 to receive the set of sensory data 356, while the output device 610 is configured to provide the optimized transmit power P_{TX} to the RNs 304, 312, 324, 326, 328, and 330.

The processing circuit 604, which can be a field-programmable gate array (FPGA) or an application-specific integrated circuit (ASIC), as an example, includes at least one processor 612 (e.g., a microprocessor) and an embedded memory 614 (e.g., a flash memory). In a non-limiting example, the embedded memory 614 can store computer instructions to program the processor 616 to carry out the high-level process 400 of FIG. 4 and the low-level process 500 of FIG. 5. The embedded memory 614 may also store the set of sensory data 356 and the stationary device table.

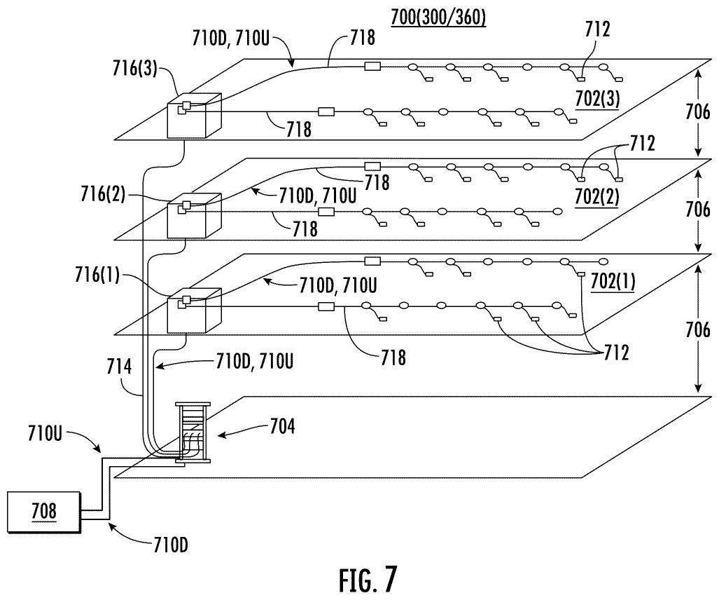

The WCS 300 of FIG. 3, which can include the computing device 360 in FIG. 6, can be provided in an indoor environment as illustrated in FIG. 7. FIG. 7 is a partial schematic cut-away diagram of an exemplary building infrastructure 700 in a WCS, such as the WCS 300 of FIG. 3 that includes the computing device 360 of FIG. 7 to perform machine learning assisted energy saving optimization. The building infrastructure 700 in this embodiment includes a first (ground) floor 702(1), a second floor 702(2), and a third floor 702(3). The floors 702(1)-702(3) are serviced by a central unit 704 to provide antenna coverage areas 706 in the building infrastructure 700. The central unit 704 is communicatively coupled to a base station 708 to receive downlink communications signals 710D from the base station 708. The central unit 704 is communicatively coupled to a plurality of remote units 712 to distribute the downlink communications signals 710D to the remote units 712 and to receive uplink communications signals 710U from the remote units 712, as previously discussed above. The downlink communications signals 710D and the uplink communications signals 710U communicated between the central unit 704 and the remote units 712 are carried over a riser cable 714. The riser cable 714 may be routed through interconnect units (ICUs) 716(1)-716(3) dedicated to each of the floors 702(1)-702(3) that route the downlink communications signals 710D and the uplink communications signals 710U to the remote units 712 and also provide power to the remote units 712 via array cables 718.

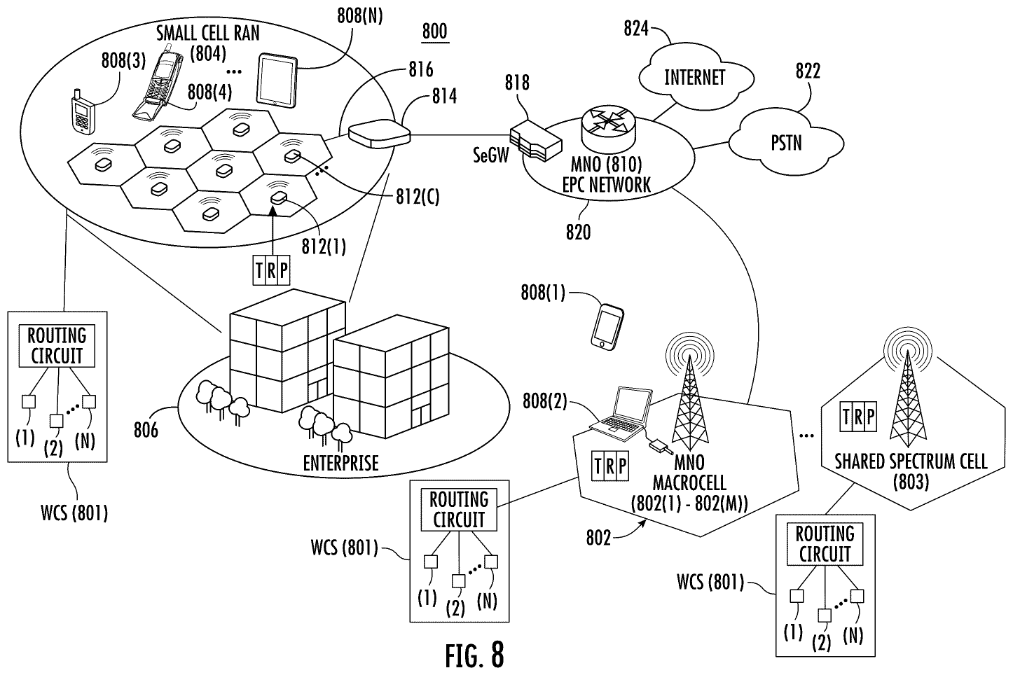

The WCS 300 of FIG. 3 and the computing device 360 of FIG. 7, configured to perform machine learning assisted energy saving optimization, can also be interfaced with different types of radio nodes of service providers and/or supporting service providers, including macrocell systems, small cell systems, and remote radio heads (RRH) systems, as examples. For example, FIG. 8 is a schematic diagram of an exemplary mobile telecommunications environment 800 (also referred to as “environment 800”) that includes radio nodes and cells that may support shared spectrum, such as unlicensed spectrum, and can be interfaced to shared spectrum WCSs 801 supporting coordination of distribution of shared spectrum from multiple service providers to remote units to be distributed to subscriber devices. The shared spectrum WCSs 801 can include the WCS 300 of FIG. 3 that includes the computing device 360 of FIG. 7, as an example.

The environment 800 includes exemplary macrocell RANs 802(1)-802(M) (“macrocells 802(1)-802(M)”) and an exemplary small cell RAN 804 located within an enterprise environment 806 and configured to service mobile communications between a user mobile communications device 808(1)-808(N) to a mobile network operator (MNO) 810. A serving RAN for the user mobile communications devices 808(1)-808(N) is a RAN or cell in the RAN in which the user mobile communications devices 808(1)-808(N) have an established communications session with the exchange of mobile communications signals for mobile communications. Thus, a serving RAN may also be referred to herein as a serving cell. For example, the user mobile communications devices 808(3)-808(N) in FIG. 8 are being serviced by the small cell RAN 804, whereas the user mobile communications devices 808(1) and 808(2) are being serviced by the macrocell 802. The macrocell 802 is an MNO macrocell in this example. However, a shared spectrum RAN 803 (also referred to as “shared spectrum cell 803”) includes a macrocell in this example and supports communications on frequencies that are not solely licensed to a particular MNO, such as CBRS for example, and thus may service user mobile communications devices 808(1)-808(N) independent of a particular MNO. For example, the shared spectrum cell 803 may be operated by a third party that is not an MNO and wherein the shared spectrum cell 803 supports CBRS. Also, as shown in FIG. 8, the MNO macrocell 802, the shared spectrum cell 803, and/or the small cell RAN 804 can interface with a shared spectrum WCS 801 supporting coordination of distribution of shared spectrum from multiple service providers to remote units to be distributed to subscriber devices. The MNO macrocell 802, the shared spectrum cell 803, and the small cell RAN 804 may be neighboring radio access systems to each other, meaning that some or all can be in proximity to each other such that a user mobile communications device 808(3)-808(N) may be able to be in communications range of two or more of the MNO macrocell 802, the shared spectrum cell 803, and the small cell RAN 804 depending on the location of the user mobile communications devices 808(3)-808(N).

In FIG. 8, the mobile telecommunications environment 800 in this example is arranged as an LTE system as described by the Third Generation Partnership Project (3GPP) as an evolution of the GSM/UMTS standards (Global System for Mobile communication/Universal Mobile Telecommunications System). It is emphasized, however, that the aspects described herein may also be applicable to other network types and protocols. The mobile telecommunications environment 800 includes the enterprise environment 806 in which the small cell RAN 804 is implemented. The small cell RAN 804 includes a plurality of small cell radio nodes 812(1)-812(C). Each small cell radio node 812(1)-812(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 8, the small cell RAN 804 includes one or more services nodes (represented as a single services node 814) that manage and control the small cell radio nodes 812(1)-812(C). In alternative implementations, the management and control functionality may be incorporated into a radio node, distributed among nodes, or implemented remotely (i.e., using infrastructure external to the small cell RAN 804). The small cell radio nodes 812(1)-812(C) are coupled to the services node 814 over a direct or local area network (LAN) connection 816 as an example, typically using secure IPsec tunnels. The small cell radio nodes 812(1)-812(C) can include multi-operator radio nodes. The services node 814 aggregates voice and data traffic from the small cell radio nodes 812(1)-812(C) and provides connectivity over an IPsec tunnel to a security gateway (SeGW) 818 in a network 820 (e.g., evolved packet core (EPC) network in a 4G network, or 5G Core in a 5G network) of the MNO 810. The network 820 is typically configured to communicate with a public switched telephone network (PSTN) 822 to carry circuit-switched traffic, as well as for communicating with an external packet-switched network such as the Internet 824.

The environment 800 also generally includes a node (e.g., eNodeB or gNodeB) base station, or “macrocell” 802. The radio coverage area of the macrocell 802 is typically much larger than that of a small cell where the extent of coverage often depends on the base station configuration and surrounding geography. Thus, a given user mobile communications device 808(3)-808(N) may achieve connectivity to the network 820 (e.g., EPC network in a 4G network, or 5G Core in a 5G network) through either the macrocell 802 or the small cell radio nodes 812(1)-812(C) in the small cell RAN 804 in the environment 800.

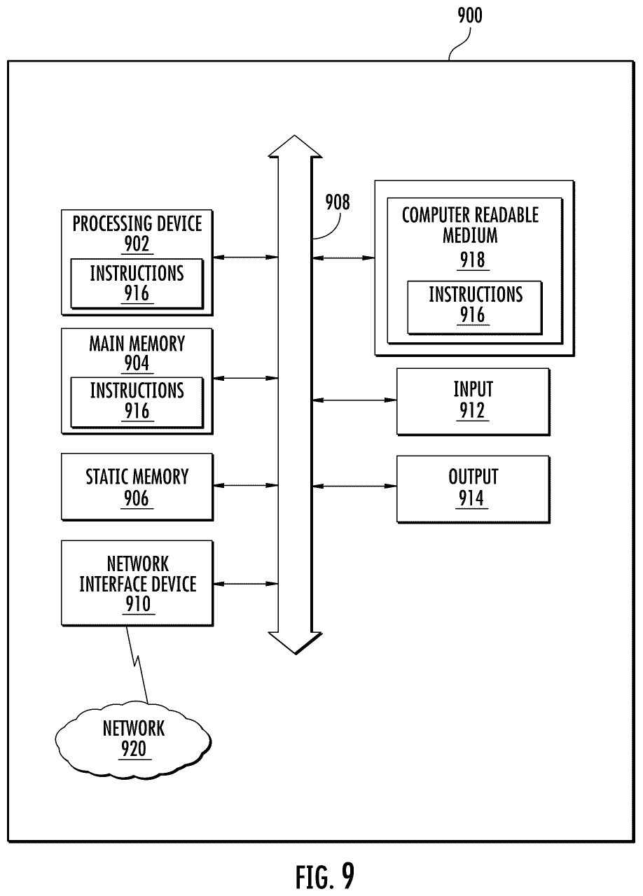

Any of the circuits in the WCS 300 of FIG. 3 and the computing device 360 of FIG. 7, such as the processing circuit 704, can include a computer system 900, such as that shown in FIG. 9, to carry out their functions and operations. With reference to FIG. 9, the computer system 900 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 900 in this embodiment includes a processing circuit or processor 902, a main memory 904 (e.g., read-only memory (ROM), flash memory, dynamic random access memory (DRAM) such as synchronous DRAM (SDRAM), etc.), and a static memory 906 (e.g., flash memory, static random access memory (SRAM), etc.), which may communicate with each other via a data bus 908. Alternatively, the processing circuit 902 may be connected to the main memory 904 and/or the static memory 906 directly or via some other connectivity means. The processing circuit 902 may be a controller, and the main memory 904 or the static memory 906 may be any type of memory.

The processing circuit 902 represents one or more general-purpose processing circuits such as a microprocessor, central processing unit, or the like. More particularly, the processing circuit 902 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 902 is configured to execute processing logic in instructions 916 for performing the operations and steps discussed herein.

The computer system 900 may further include a network interface device 910. The computer system 900 also may or may not include an input 912 to receive input and selections to be communicated to the computer system 900 when executing instructions. The computer system 900 also may or may not include an output 914, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 900 may or may not include a data storage device that includes the instructions 916 stored in a computer-readable medium 918. The instructions 916 may also reside, completely or at least partially, within the main memory 904 and/or within the processing circuit 902 during execution thereof by the computer system 900, the main memory 904 and the processing circuit 902 also constituting the computer-readable medium 918. The instructions 916 may further be transmitted or received over a network 920 via the network interface device 910.

While the computer-readable medium 918 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing circuit and that cause the processing circuit to perform any one or more of the methodologies of the embodiments disclosed herein. The term “computer-readable medium” shall accordingly be taken to include, but not be limited to, solid-state memories, optical and magnetic medium.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.), and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components and/or systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented as electronic hardware, instructions stored in memory or in another computer-readable medium and executed by a processor or other processing device, or combinations of both. The various illustrative logical blocks, modules, and circuits described in connection with the embodiments disclosed herein may be implemented with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein, as examples. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A method for optimizing energy saving in a wireless communications system (WCS), comprising:
receiving a set of sensory data collected for one or more radio nodes (RNs) among a plurality of RNs in the WCS;
invoking a machine learning (ML) service to process the set of sensory data to thereby assign each of the one or more RNs to a power category;
optimizing the assigned power category to thereby determine an optimized transmit power for each of the one or more RNs; and
configuring each of the one or more RNs to transmit in the optimized transmit power.

2. The method of claim 1, further comprising receiving the set of sensory data from a sensor gateway (SG) based on one or more of a Message Queuing Telemetry Transport (MQTT) protocol, a Constrained Application Protocol (CoAP) protocol, and a Lightweight Machine-to-Machine (LWM2M) protocol.

3. The method of claim 1, further comprising collecting the set of sensory data through a proximity sensor network co-existing with the plurality of RNs in the WCS.

4. The method of claim 1, wherein invoking the ML service comprises one or more of:
invoking the ML service in response to receiving the set of sensory data; and
invoking the ML service in accordance with a predefined energy optimization schedule.

5. The method of claim 1, wherein invoking the ML service comprises:
determining a respective user cluster for each of the one or more RNs based on the set of sensory data; and
classifying the respective user cluster into the power category.

6. The method of claim 5, wherein classifying the respective user cluster into the power category comprises classifying the respective user cluster into one of: a power-off category associated with a first power level that equals zero, a low-power category associated with a second power level higher than the first power level, a medium-power category associated with a third power level higher than the second power level, and a high-power category associated with a fourth power level higher than the third power level.

7. The method of claim 1, further comprising optimizing the power category for each of the one or more RNs based on a stationary device table comprising a list of RNs among the plurality of RNs each configured to serve at least one stationary device.

8. The method of claim 7, further comprising invoking the ML service to produce the stationary device table.

9. The method of claim 7, wherein the stationary device table comprises a respective identification and a respective transmit power level for each of the list of RNs.

10. The method of claim 9, further comprising:
determining a number of UEs actively connected to each of the one or more RNs via radio resource control (RRC) layer signaling;
increasing the respective transmit power level for a respective one of the one or more RNs if the number of UEs actively connected to the respective one of the one or more RNs is higher than a number of UEs planned to be served by the respective one of the one or more RNs; and
adding the respective one of the one or more RNs to the stationary device table if the respective one of the one or more RNs is not in the stationary device table.

11. A wireless communications system (WCS), comprising:
a plurality of radio nodes (RNs) each configured to serve a respective one of a plurality of coverage areas;
a proximity sensor network co-existing with the plurality of RNs and configured to collect a set of sensory data for one or more RNs among a plurality of RNs in the WCS; and
a computing device configured to:
receive the set of sensory data from the sensor network;
invoke a machine learning (ML) service to process the set of sensory data to thereby assign each of the one or more RNs to a power category;
optimize the assigned power category to thereby determine an optimized transmit power for each of the one or more RNs; and
configure each of the one or more RNs to transmit in the optimized transmit power.

12. The WCS of claim 11, wherein the computing device is coupled to a sensor gateway (SG) and is further configured to receive the set of sensory data from the SG based on one or more of a Message Queuing Telemetry Transport (MQTT) protocol, a Constrained Application Protocol (CoAP) protocol, and a Lightweight Machine-to-Machine (LWM2M) protocol.

13. The WCS of claim 12, wherein the computing device is provided in one of a central unit (CU) and a distribution unit (DU) in the WCS and interfaced with the SG via a cross-platform application (xApp).

14. The WCS of claim 11, wherein the computing device is further configured to invoke the ML service in response to one or more of:
receiving the set of sensory data; and
in accordance with a predefined energy optimization schedule.

15. The WCS of claim 11, wherein the computing device is further configured to invoke the ML service to:
determine a respective user cluster for each of the one or more RNs based on the set of sensory data; and
classify the respective user cluster into the power category.

16. The WCS of claim 15, wherein the respective user cluster comprises a power-off category associated with a first power level that equals zero, a low-power category associated with a second power level higher than the first power level, a medium-power category associated with a third power level higher than the second power level, and a high-power category associated with a fourth power level higher than the third power level.

17. The WCS of claim 11, wherein the computing device is further configured to optimize the power category for each of the one or more RNs based on a stationary device table comprising a list of RNs among the plurality of RNs each configured to serve at least one stationary UE.

18. The WCS of claim 17, wherein the computing device is further configured to invoke the ML service to produce the stationary device table.

19. The WCS of claim 17, wherein the stationary device table comprises a respective identification and a respective transmit power level for each of the list of RNs.

20. The WCS of claim 19, wherein the computing device is further configured to:
determine a number of UEs actively connected to each of the one or more RNs via radio resource control (RRC) layer signaling;
increase the respective transmit power level for a respective one of the one or more RNs if the number of UEs actively connected to the respective one of the one or more RNs is higher than a number of UEs planned to be served by the respective one of the one or more RNs; and
add the respective one of the one or more RNs to the stationary device table if the respective one of the one or more RNs is not in the stationary device table.
